(19) United States
(12) Patent Application Publication
(10) Pub. No.: US 2024/0419302 A1
(43) Pub. Date: Dec. 19, 2024

(54) METHOD AND APPARATUS, ELECTRONIC DEVICE AND STORAGE MEDIUM FOR PUSHING BOOKS

(71) Applicant: Beijing Zitiao Network Technology Co., Ltd., Beijing (CN)

(72) Inventors: Qi Deng, Beijing (CN); Chuanqi Jing, Beijing (CN); Jinghua Li, Beijing (CN)

(21) Appl. No.: 18/672,365

(22) Filed: May 23, 2024

(30) Foreign Application Priority Data
Jun. 16, 2023 (CN) 202310721251.8

(51) Int. Cl. G06F 3/0483; G06F 3/0482

(52) U.S. Cl. CPC G06F 3/0483; G06F 3/0482

(57) ABSTRACT

The present disclosure relates to a method and an apparatus, an electronic device and a storage medium for pushing books. The method comprises: obtaining character information of at least one target character, wherein the character information at least comprises a character image, a character profile, and book information of a book corresponding to the target character, and the character image is generated based on contents describing the target character in the book; and presenting a character card on a first page, wherein a first area of the character card is used to display the character image, and a second area of the character card is used to display information in the character information other than the character image. As such, it can push book information in the character dimension, to improve the reading conversion rate and the book push success rate of the book corresponding to the pushed character.

### CROSS-REFERENCE TO RELATED APPLICATION(S)

This application claims priority to Chinese Application No. 202310721251.8 filed in Jun. 16, 2023, the disclosure of which is incorporated herein by reference in its entity.

### FIELD

The present disclosure relates to the technical field of pushing information, in particular, to a method and apparatus, an electronic device and a storage medium for pushing books.

### BACKGROUND

The boom of mobile terminals brings a surge of e-books. In order to help users to efficiently filter books from a plurality of e-books, book applications are developed to filter out books of interest to some users from the plurality of books and push the same to the users. However, due to the limited information, the pushed books may not attract users' attention, leading to a low reading conversion rate of those books.

### SUMMARY

In order to solve the above-mentioned technical problem, the present disclosure provides a method and an apparatus, an electronic device and a storage medium for pushing books.

In a first aspect, the present disclosure provides a method for pushing books, comprising:
obtaining character information of at least one target character, wherein the character information at least comprises a character image, a character profile, and book information of a book corresponding to the target character, and the character image is generated based on contents describing the target character in the book; and
presenting a character card on a first page, wherein a first area of the character card is used to display the character image, and a second area of the character card is used to display information in the character information other than the character image.

In a second aspect, the present disclosure provides an apparatus for pushing books, comprising:
a character information obtaining module for obtaining character information of at least one target character, wherein the character information at least comprises a character image, a character profile, and book information of a book corresponding to the target character, and the character image is generated based on contents describing the target character in the book; and
a character card presenting module for presenting a character card on a first page, wherein a first area of the character card is used to display the character image, and a second area of the character card is used to display information in the character information, other than the character image.

In a third aspect, the present disclosure provides an electronic device, comprising:
a processor; and
a memory for storing executable instructions;
wherein the processor is used to read the executable instructions from the memory and execute the executable instructions to implement the method for pushing books as described in any embodiment of the present disclosure.

In a fourth aspect, the present disclosure provides a computer readable storage medium, wherein the computer readable storage medium stores computer programs that, when executed by a processor, cause the processor to implement the method for pushing books as described in any embodiment of the present disclosure.

The method and apparatus, the electronic device and the storage medium for pushing books according to the embodiments of the present disclosure can implement: obtaining character information of at least one target character, where the character information at least comprises a character image generated based on contents describing the target character in the book, a character profile, and book information of a book corresponding to the target character; and presenting a character card on a first page, wherein a first area of the character card is used to display the character image, and a second area of the character card is used to display information in the character information other than the character image. As such, the character information in books can be pushed, to enable a user to quickly learn the related information of poplar characters in books, and promote user's interest in the books containing the character. Accordingly, book information can be pushed in the character dimension, to improve the reading conversion rate and the book push success rate of the books corresponding to the pushed character.

### BRIEF DESCRIPTION OF THE DRAWINGS

The above and other objectives, features, and advantages of the present disclosure will become more apparent, through the following implementations with reference to the accompanying drawings. Throughout the drawings, the same or similar reference symbols refer to the same or similar components. It would be appreciated that the drawings are provided exemplarily, where the components and elements are not necessarily drawn to scale.

FIG. 1 illustrates a flowchart of a method for pushing books provided by embodiments of the present disclosure;

FIG. 2 illustrates a schematic diagram of a display of a first page provided by embodiments of the present disclosure;

FIG. 3 illustrates a schematic diagram of a display of another first page provided by embodiments of the present disclosure;

FIG. 4 illustrates a schematic diagram of a second display provided by embodiments of the present disclosure;

FIG. 5 illustrates a schematic diagram of a display of a second page after label switching provided by embodiments of the present disclosure;

FIG. 6 illustrates a schematic diagram of a structure of an apparatus for pushing books provided by embodiments of the present disclosure; and

FIG. 7 illustrates a schematic diagram of a structure of an electronic device provided by embodiments of the present disclosure.

### DETAILED DESCRIPTION OF EMBODIMENTS

Reference now will be made to the drawings to describe in detail the embodiments of the present disclosure. Although the drawings show some embodiments of the present disclosure, the present disclosure can be implemented in various forms, which should not be construed as being confined to the embodiments illustrated therein. Instead, those embodiments are provided only to enable those skilled in the art to understand the present disclosure more thoroughly and completely. It would be appreciated that the drawings and embodiments of the present disclosure are provided exemplarily, without suggesting any limitation to the protection scope of the present disclosure.

It is to b understood that respective steps in the implementations of the method according to the present disclosure may be performed in different orders and/or performed in parallel. In addition, the method implementations may include additional steps and/or steps omitted. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

For book reading applications, e-books are pushed mainly through book information, book lists, topics, and the like, and in the form of pictures and text. However, the pushed information in the methods for pushing books are too general to arouse users' interest in reading. On the basis, the embodiments of the present disclosure provide a solution for pushing books to push character cards including character images, character profiles, and book information, to users to acquire more detailed information of the books, so as to achieve a book being pushed from the perspective of popular characters contained in books and thus improve the efficiency of pushing books and conversion rate of reading books.

The method for pushing books provided by the embodiments of the present application can be applied to the scenario of pushing e-books by book reading applications. The method can be performed by an apparatus for pushing books which can be implemented in the form of software and/or hardware, and integrated in an electronic device with a display function. The electronic device may include, but is not limited to, a mobile terminal such as a mobile phone, a laptop computer, a Personal Digital Assistant (PDA), a Tablet Personal Computer (Tablet PC), an on-vehicle terminal (e.g. an on-vehicle navigation terminal) or the like, or a fixed terminal such as a digital TV, a desktop computer or the like.

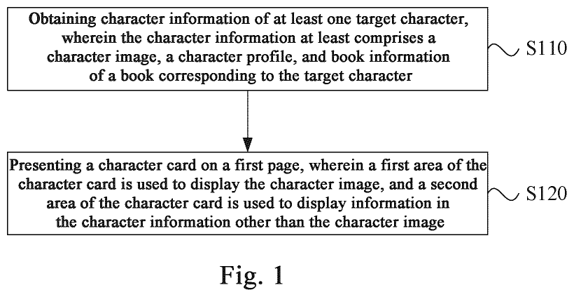

FIG. 1 illustrates a flowchart of a method for pushing books provided by embodiments of the present disclosure. As shown therein, the method for pushing books may include the following steps:

S110: obtaining character information of at least one target character at least including a character image, a character profile, and book information of a book corresponding to the target character.

Wherein, the target character is a character to be pushed to a certain user (referred to as target user hereinafter), which may be a character in a certain book set according to the service need, or may be a character in a certain book selected randomly, or may be a character determined according to the reading interest of the target user and/or the popularity of the character.

By way of example, the target character is determined from a plurality of candidate characters based on a character popularity value and a first book type corresponding to the target user. That is, the target character is filtered from a plurality of candidate characters included in a plurality of books based on the character popularity and the reading interest of the target user. The character popularity value used here is a numerical indicator value characterizing a popularity of a character in a book. The character popularity value is determined based on a discussion popularity of a character and/or a reading popularity of a book corresponding to the character. The discussion popularity herein may be characterized by at least one of the following indicators: a number and quality of comments about the character, a number and quality of character discussion posts posted by users, an amount of interactions (e.g., likes, shares, etc.) of the comments and/or the character discussion posts, a reading conversion rate of a corresponding book based on the character discussion posts or the character cards presented according to the embodiments of the present disclosure, and the like. The reading popularity here may be characterized by at least one of: a number of users reading the book, a reading time of the book, a number of days that users are active, and the like. The first book type as mentioned above is a book type of interest to the target user. For example, if the target user is interested in “time travel,” the first book type may be a “time-travel” type. The first book type may be determined depending on types of books read by the target user in a historical period, or may be determined based on a preferred book type input by the target user.

Wherein, the character image is an image characterizing a character image. The character image may be an image preset based on a character in a book, or may be generated automatically according to related information of a character. In the embodiments of the present disclosure, the character image is generated based on contents describing a target character in a book. In other words, the character image is automatically generated based on image-related contents describing a target character in a book. This ensures that the character image fits with the target character to a great degree, to thus present the target character intuitively and vividly.

Wherein, the character profile comprises contents briefly introducing a target character, which may be, for example, words related to the target character in a book, an important plot related to the target character, a summary generated based on various contents related to the target character in the book, and the like. There may be one or more character profiles. For example, when the target character or the corresponding books thereof correspond to multiple book style types, a character profile matching in style is determined for each book style type. The book information is related information for introducing a book, which may be, for example, a book name, a book type, whether a book is completed or updated, or a reading popularity of a book, or the like.

Specifically, when determining that a pushing book condition is met, the electronic device obtains character information of at least one target character to be pushed. In order to enrich the pushed character information, the electronic device may obtain a character image of the target character to present the character image intuitively and vividly, or may obtain a character profile of the target character, to present information in more dimensions of the target character in the form of text, or may obtain book information of a book where the target character is included, to accomplish the purpose of pushing the corresponding book through the target character.

The pushing book condition may be a timing cycle or a set user operation. When the pushing book condition is a set user operation, S110 may be implemented as one of the following: in response to an operation of starting a book reading application, obtaining, by the electronic device, character information; in response to a book searching operation, obtaining, by the electronic device, character information; in response to a switch operation on a book recommendation page or a discussion community/book circle page corresponding to the book, obtaining, by the electronic device, character information, or the like.

In some embodiments, the character image is generated by an artificial intelligence image model based on contents describing the target character in the book.

Specifically, in order to improve the matching degree between the character image and the target character, and promote the accuracy of the character image, multi-dimensional text contents related to the target character can be extract from the book where the target character is included, for example, text related to description of age, gender, identity, appearance features, clothing features, action features, and surroundings of the target character. Then, the artificial intelligence image generation model for generating an image out of text, for example, a stable diffusion (SD) model in an AI Generated Content (AI Generated Content) model, a Midjourney model, a DALL-E 2 image generator, and the like, may be used to generate the character image of the target character based on the extracted description text.

It is to be noted that the text describing the target character may be text pre-input by related personnel, for example, text input by the related personnel (e.g. a developer, a user, or the like) based on the understanding of the plot of the book and the target character.

In some embodiments, the character image may be pre-generated by: obtaining the contents describing the target character in the book, and an image style identifier corresponding to the book; pre-processing the contents describing the target character in the book to generate pre-processed text; and inputting the pre-processed text and the image style identifier into the artificial intelligence image generation model to output the character image.

Wherein, the image style identifier is identification information for characterizing an image style, for example, a name or code of a preset image style, or the like. The style herein refers to an imaging style of an image, and an overall color style, a tone style, a light style, and the like of an image, where the imaging style includes an appearance, a body shape, a hair style, clothing, and the like, of a character, as well as a spatial layout and a hierarchy of image elements, and the like. For example, the image style may be western style, ancient style, modern style, comic style, crayon style, ink-painting style, oil-painting style, sketch style, and the like. The image style is determined based on a book content context of the book, for example, a historical background, cultural background, and the like, of the storyline in the book.

Specifically, the text describing the target character is extracted from the book corresponding to the target character, and an image style identifier is determined from the book content background. Then, text denoising is performed on the text describing the target character, to improve the smoothness and conciseness of the text. In the meantime, according to the model input data requirement of the pre-trained artificial intelligence image generation model, corresponding processing (e.g., translation into English) is performed on the denoised text, to obtain the pre-processed text. Subsequently, the pre-processed text and the image style identifier are input into the artificial intelligence image generation model, and the character image is output after the processing of the model.

It is to be noted that, in order to further improve the matching degree between the image style of the character image and the book content background, when the text is input into the model, the weight of the image style identifier can be increased to enhance the function of the image style identifier in the image generation process.

S120: presenting a character card on a first page, where a first area of the character card is used to display the character image, and a second area of the character card is used to display information in the character information other than the character image.

Wherein, the first page is a page for presenting the pushed character information, which may be, for example, a book recommendation page (e.g. a home page of book reading applications), a search page, a book community/book circle page for a plurality of users to discuss book-related information, and the like. The first area and the second area are different display areas in the character card, where the positional relationship, the area size, and the like, of the two can be preset.

Specifically, after obtaining character information, the electronic device can present the character information to the user. For example, the electronic device can render the character information, to generate the character cards, and display, on the first page, the character cards of at least part of the target characters. The character image of the target character is displayed in the first area of each of the character cards, and other remaining information in the character information is displayed in the second area.

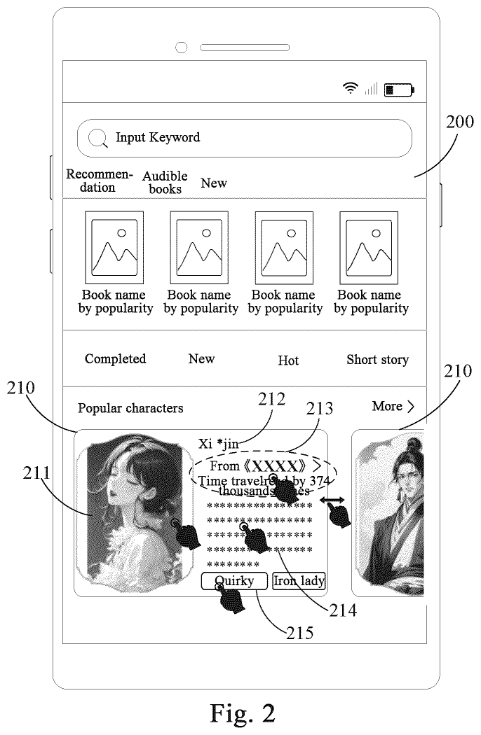

Referring to FIG. 2, the electronic device displays, on a book recommendation page 200, a popular character module in which character cards 210 of a plurality of target characters are displayed. Wherein, a character image 211 is displayed in the first area of the image card 210, and an image name 212, book information 213, and a character profile 214 are displayed in the second area. Limited by the display area of the electronic device, the plurality of character cards 210 are arranged and displayed in a horizontal or vertical manner.

In some embodiments, the character information further includes a character label. The character label is used to characterize comprehensive features of the target character, where the comprehensive features include an identity characteristic and a temperament characteristic. The character label may be a keyword label preset by related personnel, or may be determined based on a book type of a book corresponding to the target character. If the book type is a multi-level type, the character label is determined according to a type at the finest level, to improve the characterization fineness of the character label for characterizing comprehensive features of the target character. Referring to FIG. 2, the electronic device can also display a corresponding character label 215 in the character card 210.

On the basis of the above-mentioned embodiment, S120 comprises: displaying, on the first page, a target character list that at least includes the character card.

Wherein, the target character list a character ranking list of character cards matching the target character. The target character list can be filtered from a plurality of candidate character lists based on the character label. As such, the list type of the character list can be characterized by the character label. In this way, a target character list can be filtered from a plurality of character lists based on the character label of the target character.

Specifically, the electronic device can distribute character cards in the form of a character list. In the case, the electronic device can push the target character list on the first page and display character cards of the target character in the target character list.

In some embodiments, the target character list is a character list having a list type matching the first book type corresponding to the target user in the plurality of candidate character lists.

Specifically, in order to improve the match degree between the pushed target character list and the reading interest of the target user, filtering the character list may further include matching the first book type of interest to the target user with the character labels corresponding to the respective character lists, in addition to matching with the character label of the target character. In this way, the target character list can be filtered from the plurality of candidate character lists, which matches the character label of the target character and the first book type of interest to the target user.

On the basis of the above embodiments, the character profile is determined from a plurality of candidate profiles corresponding to the target character based on the first book type and/or the target character list.

Specifically, if there is a plurality of character profiles, after determining the target character list, a character profile matching therewith can be filtered from the plurality of character profiles for pushing, based on the list type of the target character list, in order to improve the match degree of the character profile. Likewise, in order to improve the match degree between the character profile and the reading interest of the target user, a character profile matching therewith can be filtered from the plurality of character profiles for pushing, based on the first book type.

In some embodiments, the candidate character list is generated based on character popularity values of characters of the same type in a plurality of books.

Wherein, the characters of the same type are characters with a character label matching the list type in the respective candidate characters included in the plurality of books, and the character popularity value is determined based on a reading popularity of a book corresponding to the candidate character and/or a discussion popularity of the candidate character.

Specifically, the candidate character list includes characters having the same character label in a plurality of books, where the character label is consistent with the list type of the candidate character list. In addition, the respective characters in the candidate character list are sorted according to the character popularity value.

The method for pushing books provided by the various embodiments of the present disclosure, as described above, includes: obtaining character information of at least one target character, where the character information at least comprises a character image generated based on contents describing the target character in the book, a character profile, and book information of a book corresponding to the target character; and presenting a character card on a first page, where a first area of the character card is used to display the character image, and a second area of the character card is used to display information in the character information other than the character image. As such, the character information in books can be pushed, to enable a user to quickly learn the related information of poplar characters in books, and promote user's interest in the books containing the character. Accordingly, book information can be pushed in the character dimension, so as to improve the reading conversion rate and the book push success rate of the books corresponding to the pushed character.

In some embodiments, after S120, the method for pushing books further comprises: in response to a trigger operation on the book information in the character card, displaying a book page corresponding to the book.

Specifically, referring to FIG. 2, after the target user performs the trigger operation on the book information 213 in the character card 210, the electronic device jumps from the first page to a book page of the book corresponding to the target character in response to the trigger operation, to display more information of the book and an entry thereto.

In some embodiments, after S120, the method for pushing books further comprises: in response to a trigger operation on the character image or character profile in the character card, displaying a character detail page of the target character corresponding to the triggered character card.

Specifically, referring to FIG. 2, the target user can perform the trigger operation on the card name 212, the character image 211, or the character profile 214 in the character card 210. Upon detecting the trigger operation, the electronic device jumps from the first page to the character detail page of the target character, to present more detailed information related to the target character.

In some embodiments, after S120, the method further for pushing books comprises: in an event that the character card displays a character label of the target character, in response to a trigger operation on the character label, displaying a second page of a character type corresponding to the triggered character label.

Specifically, referring to FIG. 2, the target user can perform the trigger operation on the character label 215 in the character card 210. Upon detecting the trigger operation, the electronic device jumps from the first page to the second page corresponding to the character label. The character cards of the plurality of characters with the character label are displayed on the second page.

In some embodiments, after S120, the method for pushing books further comprises: in an event that there is a plurality of the target characters, in response to a switching operation on the character cards, switching a display of the character card of one target character to a display of the character card of another target character.

Specifically, in the case of a plurality of target character, there is a plurality of corresponding character cards. On the first page, the character cards may be arranged and displayed in a certain direction (horizontal or vertical direction), or may be displayed collectively in the form of a card album. The card album here may be achieved in such manner of fully displaying the initial character card and stacking the remaining character cards in a partial occlusion manner, to occupy the display space as little as possible while still enabling the user to know the presence of the plurality of character cards. For the character cards, the target user can display the respective character cards by switching through a preset interactive operation with a switch function.

Referring to FIG. 2, a horizontal arrangement of a plurality of character cards is taken as an example. When a plurality of character cards 210 is displayed on the first page, the electronic device can switch from a display of a character card to a display of another character card in response to the operation of switching the character card performed by the target user (e.g. the swipe operation to the left or right or the click operation performed in FIG. 2).

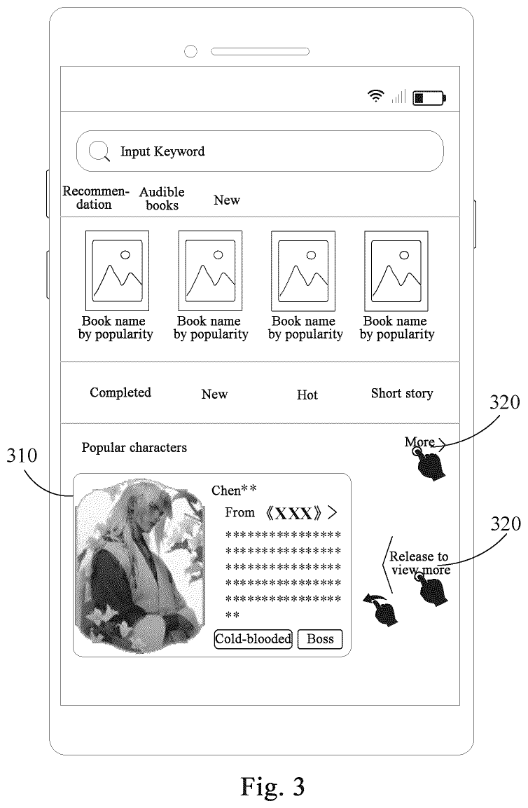

Referring to FIG. 3, if the target user performs continuous rightward swipe operations to the end in FIG. 2, the character card displayed previously is switched to the last character card 310.

In some embodiments, after S120, the method for pushing books further includes: in response to a trigger operation to a “View More” control on the first page, displaying a second page; displaying, on the second page, first-level labels, second-level labels subordinate to the first-level labels, and a first character card set, where the first character card set includes a plurality of the character cards corresponding to the selected second-level label subordinate to the selected first-level label.

Wherein, the “View More” control is a preset interactive control for displaying more character cards. For example, as shown in FIG. 3, the View More control may be an interactive control 320 for displaying “More” text, or may be an interactive control 320 with an operation prompt “Release to view more,” which is displayed after switched to the last character card.

Specifically, referring to FIG. 3, the electronic device further displays the View More control 320 on the popular character module. The target user may perform the correspond trigger operation according to the operation prompt of the View More control 320. At this time, the electronic device jumps from the first page to the second page, to display more character cards.

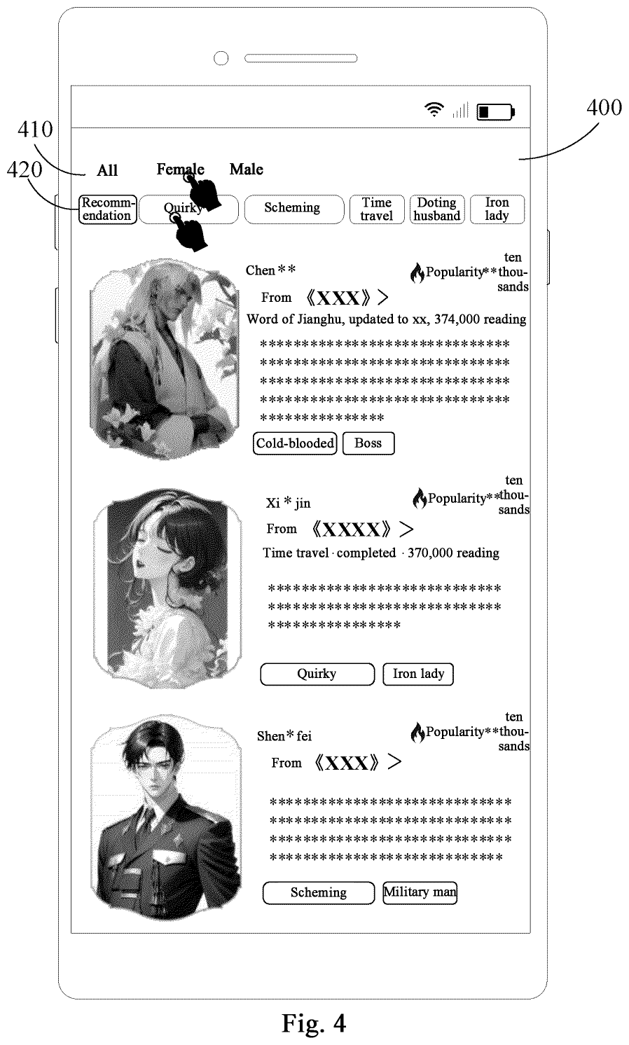

Referring to FIG. 4, in order to improve the filtering efficiency of the more character cards displayed on the second page, the electronic device may provide the first-level labels 410 (e.g. “All,” “Male,” “Female,” and the like) at the top and the second-level labels 420 (e.g. “Recommendation,” “Quirky,” “Scheming,” and the like) at the bottom. Each first-level label 410 may correspond to a plurality of second-level labels 420. When jumping to the second page 400, the electronic device selects the first-level label “All” and the second-level label “Recommendation” by default, and correspondingly display all recommended character cards.

In some embodiments, after displaying, on the second page, the first-level labels, the second-level labels subordinate to the first-level labels, and the first character card set, the method for pushing books further includes: in response to a trigger operation on any of the first-level labels, displaying on the second page the respective second-level labels corresponding to the triggered first-level label, and a second character card set, where the second character card set comprises a plurality of the character cards corresponding to the triggered first-level label; in response to a trigger operation on any of the respective second-level labels corresponding to the triggered first-level label, displaying a third character card set on the second page, where the third character card set comprises a plurality of the character cards corresponding to the triggered second-level label subordinate to the triggered first-level label.

Specifically, the target user can filter the character cards by selecting the first-level labels and the second-level labels displayed on the second page.

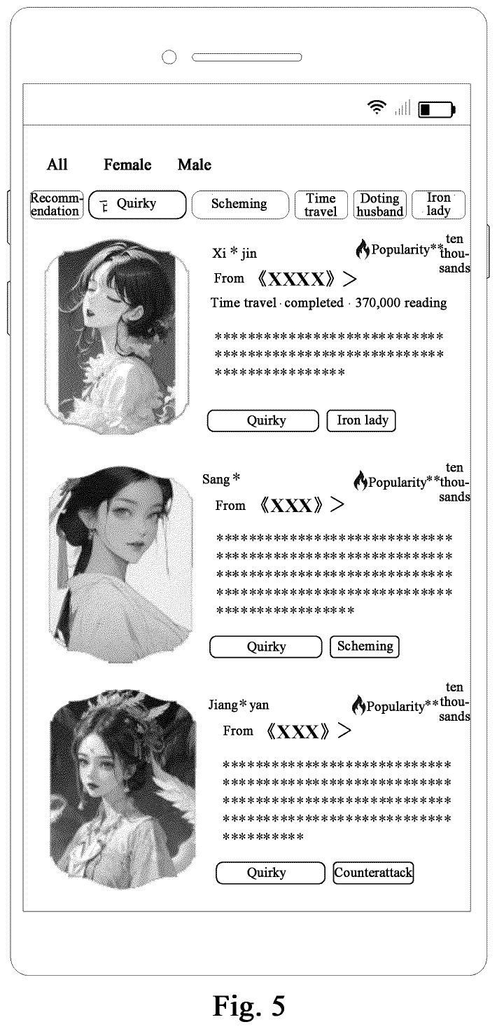

Referring to FIG. 4, after the target user performs the trigger operation on the first-level label “Female,” the electronic device displays a plurality of second-level labels corresponding to the first-level label “Female,” and respective character cards corresponding to the first-level label “Female.” After the target user performs another trigger operation on the second-level label “Quirky” in the plurality of second-level labels corresponding to the first-level label “Female,” as shown in FIG. 5, the electronic device highlights the first-level label “Female” and the second-level label “Quirky,” filters respective character cards with the character label “Quirky” from the respective character cards corresponding to the first-level label “Female,” and displays those cards in the area below the respective label levels.

Hereinafter, embodiments of the apparatus for pushing books provided by the present disclosure will be described. The apparatus and method for pushing books according to the embodiments described above belong to the same invention conception. For the details omitted in the embodiments of the apparatus for pushing books, see the embodiments of the method for pushing books described above.

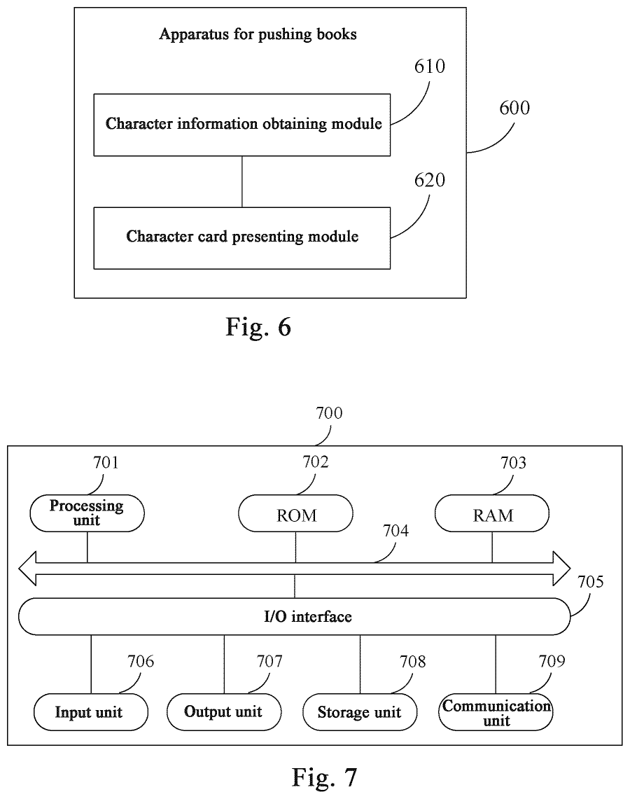

FIG. 6 illustrates a schematic diagram of a structure of an apparatus for pushing books provided by embodiments of the present disclosure. As shown therein, the apparatus for pushing books 600 may include:
a character information obtaining module 610 for obtaining character information of at least one target character, where the character information at least comprises a character image, a character profile, and book information of a book corresponding to the target character, and the character image is generated based on contents describing the target character in the book; and
a character card presenting module 620 for presenting a character card on a first page, where a first area of the character card is used to display the character image, and a second area of the character card is used to display information in the character information, other than the character image.

The apparatus for pushing books according to the embodiments of the present disclosure can implement: obtaining character information of at least one target character, where the character information at least comprises a character image generated based on contents describing the target character in the book, a character profile, and book information of a book corresponding to the target character; and presenting a character card on a first page, where a first area of the character card is used to display the character image, and a second area of the character card is used to display information in the character information other than the character image. As such, the character information in books can be pushed, to enable a user to quickly learn the related information of poplar characters in books, and promote user's interest in the books containing the character. Accordingly, book information can be pushed in the character dimension, to improve the reading conversion rate and the book push success rate of the books corresponding to the pushed character.

In some embodiments, the character label is used to characterize comprehensive features of the target character, and the comprehensive features include an identity characteristic and a temperament characteristic.

Correspondingly, the character card presenting module 620 is specifically configured to:
present, on the first page, a target character list that at least includes the character card, where the target character list is determined based on the character label.

Further, the target character list is a character list having a list type matching a first book type corresponding to a target user among a plurality of candidate character lists; and
the character profile is determined, based on the first book type and/or the target character list, from a plurality of candidate profiles corresponding to the target character.

In some embodiments, the apparatus for pushing books 600 further includes a first operation responding module configured to:
after presenting the character card on the first page, to display a book page corresponding to the book in response to a trigger operation on the book information in the character card.

In some embodiments, the apparatus for pushing books 600 further includes a second operation responding module configured to:
after presenting the character card on the first page, display a character detail page of the target character corresponding to the triggered character card in response to a trigger operation on the character image or the character profile in the character card.

In some embodiments, the apparatus for pushing books 600 further includes a third operation responding module configured to:
after presenting the character card on the first page, in an event that the character card displays a character label of the target character, display a second page of a character type corresponding to the triggered character label in response to a trigger operation on the character label.

In some embodiments, the apparatus for pushing books 600 further includes a fourth operation responding module configured to:
after presenting the character card on the first page, in an event that there is a plurality of the target characters, switch a display of the character card of one target character to a display of the character card of another target character in response to a switching operation on the character cards.

In some embodiments, the apparatus for pushing books 600 further includes a fifth operation responding module configured to:
after presenting the character card on the first page, display a second page in response to a trigger operation to a View More control on the first page; and
display, on the second page, first-level labels, second-level labels subordinate to the first-level labels, and a first character card set, where the first character card set comprises a plurality of the character cards corresponding to the selected second-level label subordinate to the selected first-level label.

In some embodiments, the apparatus for pushing books 600 further includes a sixth operation responding module configured to:
after displaying, on the second page, the first-level labels, the second-level labels subordinate to the first-level labels, and the first character card set, in response to a trigger operation on any of the first-level labels, display on the second page the respective second-level labels corresponding to the triggered first-level label, and a second character card set, where the second character card set comprises a plurality of the character cards corresponding to the triggered first-level label; and
in response to a trigger operation on any of the respective second-level labels corresponding to the triggered first-level label, display a third character card set on the second page, where the third character card set comprises a plurality of the character cards corresponding to the triggered second-level label subordinate to the triggered first-level label.

In some embodiments, the character image is generated by an artificial intelligence image generation model based on the contents describing the target character in the book, where the contents describing the target character in the book comprise text describing age, gender, identity, appearance features, clothing features, action features, and surroundings of the target character.

In some embodiments, the apparatus 600 for pushing books further includes a character image generating module for pre-generating the character image by:
obtaining the contents describing the target character in the book, and an image style identifier corresponding to the book, wherein the image style identifier is determined based on a book content context of the book;
pre-processing the contents describing the target character in the book to generate pre-processed text; and
inputting the pre-processed text and the image style identifier into the artificial intelligence image generation model to output the character image.

In some embodiments, the candidate character list is generated based on character popularity values of characters of a same type in a plurality of books, where the characters of the same type are characters with a character label matching a list type in respective candidate characters included in the plurality of books, and the character popularity value is determined based on a reading popularity of a book corresponding to the candidate character and/or a discussion popularity of the candidate character.

In some embodiments, the target character is determined from a plurality of candidate characters based on a character popularity and a first book type corresponding to a target user.

The apparatus for pushing books provided by the embodiments of the present disclosure can perform the method for pushing books provided by any of the embodiments of the present disclosure, which includes corresponding functional modules for performing the method and has the advantageous effects (details thereof are omitted here for brevity).

It is to be noted that units and modules involved in the embodiments of the apparatus for pushing books are divided according to functional logic, and the division is not limited to this as long as the corresponding functions can be implemented. In addition, the specific names of functional units are employed for differentiation, not to limit the scope of the present disclosure.

The embodiments of the present disclosure further provide an electronic device, the electronic device may include a processor, and a memory for storing executable instructions. Wherein, the processor can read the executable instructions from the memory, and execute the executable instructions to implement the method for pushing books according to the embodiments as described above.

FIG. 7 illustrates a schematic diagram of a structure of an electronic device provided by embodiments of the present disclosure.

As shown therein, the electronic device 700 may include a processing unit 701 (e.g. a central processor, a graphics processor or the like), which can execute various acts and processing based on programs stored in a Read Only Memory (ROM) 702 or a program loaded from a storage unit 708 to a Random Access Memory (RAM) 703. RAM 703 stores therein various programs and data required for operations of the electronic device 700. The processing unit 701, the ROM 702 and the RAM 703 are connected to one another via a bus 704. An input/output (I/O) interface 705 is also connected to the bus 704.

Typically, the following units may be connected to the I/O interface 705: an input unit 706 including, for example, a touchscreen, a touch pad, a keyboard, a mouse, a camera, a microphone, an accelerometer, a gyroscope and the like; an output unit 707 including, for example, a Liquid Crystal Display (LCD), a loudspeaker, a vibrator and the like; a storage unit 708 including, for example, a tape, a hard drive and the like; and a communication unit 709. The communication unit 709 can allow wireless or wired communication of the electronic device 700 with other devices to exchange data.

It is to be noted that that electronic device 700 as shown in FIG. 7 is only an example, without suggesting any limitation to the function and the application scope of the embodiments of the present disclosure. Although FIG. 7 shows the electronic device 700 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising a computer program carried on a computer readable medium, the computer program containing program code for performing the methods as in the flowcharts. In those embodiments, the computer program may be downloaded and installed from a network via the communication unit 709, or may be installed from the storage unit 708, or may be installed from the ROM 702. The computer program, when executed by the processing unit 701, performs the above-described functions defined in the method for pushing books according to the embodiments of the present disclosure.

The embodiments of the present disclosure further provide a computer readable storage medium having computer programs stored thereon, where the computer programs, when executed by a processor, cause the processor to implement the method for pushing books according to any of the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electromagnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to perform steps of the method for pushing books of any of the embodiments of the present disclosure.

In the embodiments of the present disclosure, computer program codes for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

Above described are only optimal embodiments of the present disclosure and the technical principles applied therein. It would be appreciated by those skilled in the art that the scope of the disclosure herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

1. A method for pushing books, comprising:
obtaining character information of at least one target character, wherein the character information at least comprises a character image, a character profile, and book information of a book corresponding to the target character, and the character image is generated based on contents describing the target character in the book; and
presenting a character card on a first page, wherein a first area of the character card is used to display the character image, and a second area of the character card is used to display information in the character information other than the character image.

2. The method of claim 1, wherein the character information further comprises a character label, and wherein the character label is used to characterize comprehensive features of the target character, and the comprehensive features comprise an identity characteristic and a temperament characteristic;
presenting the character card on the first page comprises:
displaying, on the first page, a target character list that at least comprises the character card, wherein the target character list is determined based on the character label.

3. The method of claim 2, wherein the target character list is a character list having a list type matching a first book type corresponding to a target user among a plurality of candidate character lists; and
the character profile is determined, based on the first book type and/or the target character list, from a plurality of candidate profiles corresponding to the target character.

4. The method of claim 1, wherein the method further comprises: after presenting the character card on the first page,
in response to a trigger operation on the book information in the character card, displaying a book page corresponding to the book.

5. The method of claim 1, wherein the method further comprises: after presenting the character card on the first page,
in response to a trigger operation on the character image or the character profile in the character card, displaying a character detail page of the target character corresponding to the triggered character card.

6. The method of claim 1, wherein the method further comprises: after presenting the character card on the first page,
in an event that the character card displays a character label of the target character, in response to a trigger operation on the character label, displaying a second page of a character type corresponding to the triggered character label.

7. The method of claim 1, wherein the method further comprises: after presenting the character card on the first page,
in an event that there is a plurality of the target characters, in response to a switching operation on the character cards, switching a display of the character card of one target characters to a display of the character card of another target characters.

8. The method of claim 1, wherein the method further comprises: after presenting the character card on the first page,
in response to a trigger operation to view more controls on the first page, displaying a second page;
displaying, on the second page, first-level labels, second-level labels subordinate to the first-level labels, and a first character card set, wherein the first character card set comprises a plurality of the character cards corresponding to the selected second-level label subordinate to the selected first-level label.

9. The method of claim 8, wherein the method further comprises: after displaying, on the second page, the first-level labels, the second-level labels subordinate to the first-level labels, and the first character card set,
in response to a trigger operation on any of the first-level labels, displaying on the second page the respective second-level labels corresponding to the triggered first-level label, and a second character card set, wherein the second character card set comprises a plurality of the character cards corresponding to the triggered first-level label;
in response to a trigger operation on any of the respective second-level labels corresponding to the triggered first-level label, displaying a third character card set on the second page, wherein the third character card set comprises a plurality of the character cards corresponding to the triggered second-level label subordinate to the triggered first-level label.

10. The method of claim 1, wherein the character image is generated by an artificial intelligence image generation model based on the contents describing the target character in the book, wherein the contents describing the target character in the book comprise text describing age, gender, identity, appearance features, clothing features, action features, and surroundings of the target character.

11. The method of claim 10, wherein the character image is pre-generated by:
obtaining the contents describing the target character in the book, and an image style identifier corresponding to the book, wherein the image style identifier is determined based on a book content context of the book;
pre-processing the contents describing the target character in the book to generate pre-processed text; and
inputting the pre-processed text and the image style identifier into the artificial intelligence image generation model to output the character image.

12. The method of claim 3, wherein the candidate character list is generated based on character popularity values of characters of a same type in a plurality of books, wherein the characters of the same type are characters with a character label matching a list type in respective candidate characters included in the plurality of books, and the character popularity is determined based on a reading popularity of a book corresponding to the candidate character and/or a discussion popularity of the candidate character.

13. The method of claim 1, wherein the target character is determined from a plurality of candidate characters based on a character popularity and a first book type corresponding to a target user.

14. An electronic device, comprising:
a processor;
a memory for storing executable instructions;
wherein the processor is used to read the executable instructions from the memory and execute the executable instructions to cause the electronic device to:
obtain character information of at least one target character, wherein the character information at least comprises a character image, a character profile, and book information of a book corresponding to the target character, and the character image is generated based on contents describing the target character in the book; and
present a character card on a first page, wherein a first area of the character card is used to display the character image, and a second area of the character card is used to display information in the character information other than the character image.

15. The electronic device of claim 14, wherein the character information further comprises a character label, and wherein the character label is used to characterize comprehensive features of the target character, and the comprehensive features comprise an identity characteristic and a temperament characteristic;
presenting the character card on the first page comprises:
displaying, on the first page, a target character list that at least comprises the character card, wherein the target character list is determined based on the character label.

16. The electronic device of claim 15, wherein the target character list is a character list having a list type matching a first book type corresponding to a target user among a plurality of candidate character lists; and
the character profile is determined, based on the first book type and/or the target character list, from a plurality of candidate profiles corresponding to the target character.

17. The electronic device of claim 14, wherein the electronic device is further caused to: after presenting the character card on the first page,
in response to a trigger operation on the book information in the character card, display a book page corresponding to the book.

18. The electronic device of claim 14, wherein the electronic device is further caused to: after presenting the character card on the first page,
in response to a trigger operation on the character image or the character profile in the character card, display a character detail page of the target character corresponding to the triggered character card.

19. The electronic device of claim 14, wherein the electronic device is further caused to: after presenting the character card on the first page,
in an event that the character card displays a character label of the target character, in response to a trigger operation on the character label, display a second page of a character type corresponding to the triggered character label.

20. A non-transitory computer readable storage medium, wherein the computer readable storage medium stores computer programs that, when executed by a processor, cause the processor to:
obtain character information of at least one target character, wherein the character information at least comprises a character image, a character profile, and book information of a book corresponding to the target character, and the character image is generated based on contents describing the target character in the book; and
present a character card on a first page, wherein a first area of the character card is used to display the character image, and a second area of the character card is used to display information in the character information other than the character image.
